(19) United States
(12) Patent Application Publication
(10) Pub. No.: US 2017/0348713 A1
(43) Pub. Date: Dec. 7, 2017

(54) System for Dispensing a Sprayable Foamable Product

(71) Applicant: Vitalii Titorov, Moscow (RU)

(72) Inventor: Vitalii Titorov, Moscow (RU)

(21) Appl. No.: 15/172,575

(22) Filed: Jun. 3, 2016

(51) Int. Cl. B05B 11/00; B05B 1/04

(52) U.S. Cl. CPC B05B 11/0037; B05B 1/04

(57) ABSTRACT

A system for the application of foamable chemical compositions is presented. The application system comprises an ergonomic handle/adapter removably attachable to a pressurized source of a foam product, the handle having inlet and outlet orifices or openings for flow of the foam product from the pressurized source to a nozzle, the nozzle having an outlet orifice for dispensing the foam product and an inlet orifice for connecting to a flexible tubular connecting member which interconnects the outlet orifice of the handle/adapter with the inlet orifice of the nozzle. The nozzle of the present invention includes design features to produce a fan shaped spray pattern of the foam product and to reduce the incidence of leakage or dripping of either moisture or the foam product at the nozzle's outlet. The tubular connecting member is flexible and therefore allows a user to spray foam into hard to reach places.

### BACKGROUND OF THE INVENTION

### Field of the Invention

The present invention relates generally to portable systems for dispensing chemical concentrates such as polyurethane foams and in particular to a spray nozzle that incorporates a metering opening to provide for a uniform fan-shaped distribution of a foamed product.

### Background of the Invention

This invention is particularly well suited for on-site applications of pressurized liquid chemicals dispensed as sprayable foams and more particularly to on-site application of polyurethane foam. On-site applications for polyurethane foam have increased substantially in recent years extending the application of polyurethane foam beyond its traditional usage in the packaging and insulation fields. For example, polyurethane foam is increasingly being used as a sealant in both residential and commercial building construction for sealing spaces between door and window frames, in addition to more traditional uses as an insulation. In cold weather climates, polyurethane foam is now commonly used as an insulator to fill essentially any air space between the wall frames of a structure. Such insulated buildings require substantially less energy to heat than non-insulated buildings.

Polyurethane foam for on-site applications is typically supplied as a “single-component” foam or as a “two-component’ foam. With both types of foam, the chemicals which create the foam are typically carried in portable containers, i.e. pressurized cylinders, and applied by an operator via an application gun. With a conventional two-component foam, the principle foamable component is typically supplied in one pressurized container while hardening agent, typically a polymeric isocyanate, is supplied in a second pressurized container. During application of a two-component foam, the pressurized cylinders containing the foamable agents and the hardener are connected to a type of spray gun where the components are mixed in appropriate ratios via metering mechanisms contained in the gun and are subsequently sprayed.

There are two principle problems with two-component polyurethane foam systems. One problem is that the guns are typically made of stainless steel and/or brass and contain precise metering mechanisms that must be cleaned shortly after use. The guns must be cleaned shortly after use because in a two-component system, the foam hardens within a relatively short period of time via chemical reaction with the isocyanate hardener. If the foam is allowed to harden within a gun, the relatively costly gun becomes unusable and typically requires disassembly and the replacement of numerous parts in the metering mechanism to return the gun to a usable state.

The other principle problem with two-component polyurethane foam systems is that the isocyanate based hardener is extremely toxic to the human nervous system. Isocyanates are readily absorbed via inhalation of vapor and skin contact. Therefore, the use of protective clothing and specialized respirators are required by workers applying a two-component polyurethane foam product.

To overcome some of the problems of two-component polyurethane foam systems, one-component foam products have been developed. In a one-component foam product, generally the resin or foamable component and the isocyanate component are supplied in a single pressurized container and dispensed through the container through a valve equipped gun, equipped with a nozzle attached to the pressurized container. With one-component polyurethane foam systems, when the foamable chemicals leave the nozzle reaction with moisture in the air causes the foam to harden. One component polyurethane foam products typically feature less overspray and introduce fewer airborne isocyanates to the atmosphere surrounding the worksite and are otherwise generally less toxic and safer to use than two-component foam systems.

With the development of single-component polyurethane foam systems, a need has arisen in the art for new foam application hardware that takes advantage of the fact that with a single-component system, there is no need to mix chemical components from two pressurized sources in precise ratios. Ideally, a new single-component foam application system would utilize low cost, easily transportable and easy to clean hardware which would allow the use of single-component polyurethane foams in a wider range of applications.

### SUMMARY OF THE INVENTION

The foam application system of the present invention comprises a pressurized source of a single-component foamable product, such as single-component polyurethane foam, an ergonomic handle removably attachable to the pressurized source of the foamable product, the handle having inlet and outlet orifices or openings for flow of the foamable product from the pressurized source, a nozzle having an inlet and an outlet orifice for dispensing the foamable product and a tubular connecting member interconnecting the outlet orifice of the handle with the inlet orifice of the nozzle.

The nozzle of the present invention includes design features to produce a fan shaped spray pattern of the foamable product and is also designed to reduce the incidence of leakage or dripping of either moisture or the foam product at the nozzle's outlet. The nozzle is further designed to be easily attachable and removable from the tubular connecting member which interconnects the nozzle with the pressurized source of the foamable product. The tubular connecting member is flexible and therefore allows a user to spray foam into hard to reach places, such as seams in walls, under surfaces, behind objects and the like. Another advantage of the flexible tubular interconnecting member is that it does not need to be cleaned after each use which provides the foam dispensing system of the present invention with an advantage over conventional systems which utilize spray guns which must be cleaned after each use.

Other advantages and novel features of the invention will become more apparent from the following detailed description of the invention when taken in conjunction with the accompanying drawings.

### BRIEF DESCRIPTION OF THE DRAWINGS

FIG. 1 is a schematic view showing one example of the arrangement of components of the foam dispensing system of the present invention, spraying foam against a wall.

FIG. 2 is a side view of the foam dispensing system of FIG. 1, with the source of a pressurized foamable product (i.e. pressurized cylinder) not shown.

FIG. 3 is a perspective view of the foam dispensing system of FIG. 1, with the pressurized cylinder not shown.

FIG. 4 is a side view of the nozzle of the foam dispensing system of FIG. 1.

FIG. 5 is a cross sectional view of the nozzle of the foam dispensing system shown in FIG. 4.

FIG. 6 is a front end view of the nozzle of the foam dispensing system shown in FIG. 4.

FIG. 7 is a side view, rotated 90° about the longitudinal axis of the nozzle of the foam dispensing system shown in FIG. 4.

FIG. 8 is a rear facing perspective view of the nozzle of the foam dispensing system shown in FIG. 4.

FIG. 9 is a front facing perspective view of the nozzle of the foam dispensing system shown in FIG. 4.

FIG. 10 is an exemplary view of a spray pattern produced by the foam dispensing system of the present invention.

### DETAILED DESCRIPTION OF THE PREFERRED EMBODIMENTS

The present invention will now be described more fully hereinafter with reference to the accompanying drawings, in which preferred embodiments of the invention are shown. The invention may, however, be embodied in many different forms and should not be construed as being limited to the embodiments set forth herein. Rather these embodiments are provided so that this disclosure will be thorough and complete, and will fully convey the scope of the invention to those skilled in the art. Like numbers refer to like elements throughout.

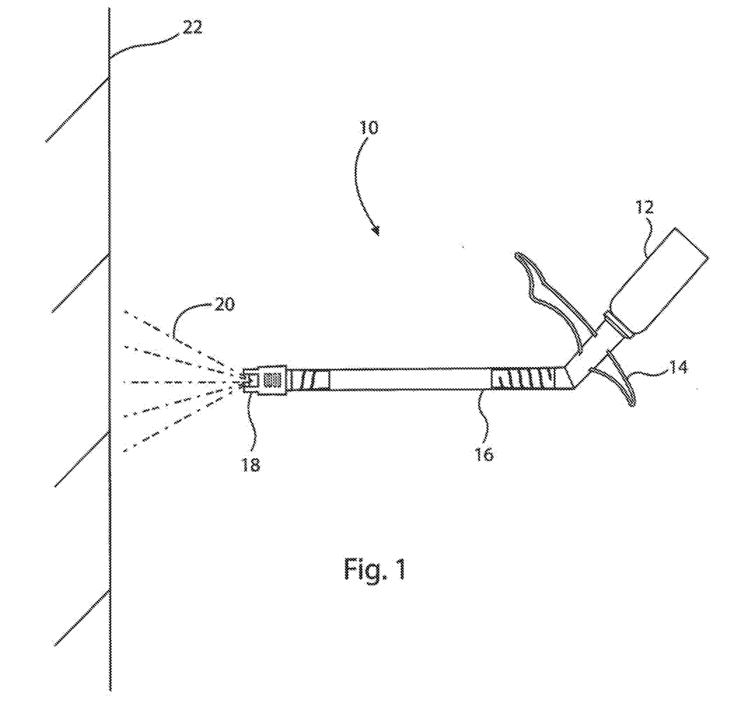

With reference to FIG. 1, the foam dispensing system of the present invention 10 comprises a pressurized source of a sprayable foam material 12, an adapter-handle 14, a flexible coupler 16 and a nozzle 18. In use, the adapter-handle 14 is connected to the source of pressurized sprayable foam material 12 and in turn is connected to the flexible coupler 16 which is connected to the nozzle 18. For exemplary purposes only, FIG. 1 depicts the foam dispensing system of the present invention spraying foam material 20 against a surface, such as a wall 22.

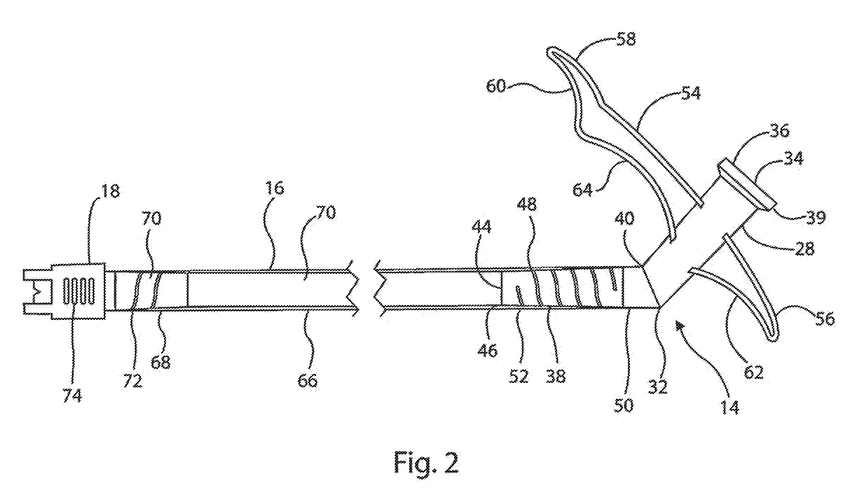

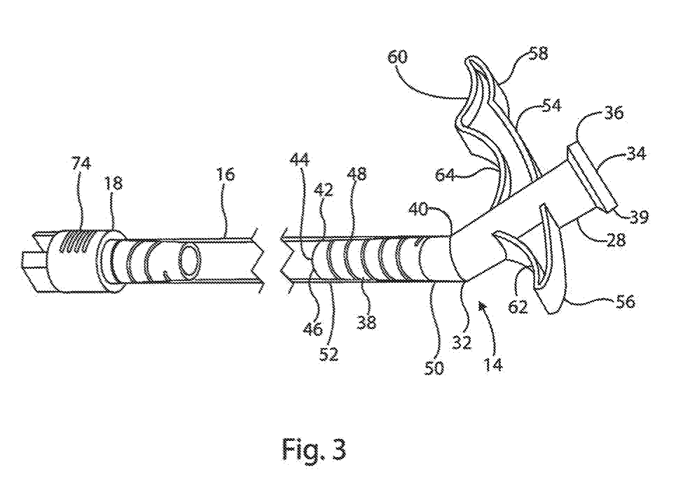

With reference to FIGS. 2 and 3, the adapter-handle 14 includes a handle portion 28 and a coupler portion 38. The handle portion 28 has an upper end 39 and a lower end 32 and a generally circular bore 34 therebetween. At the upper end 39 is a generally circular inlet opening or orifice 36. The inlet opening 36 will typically include a means which allows the inlet opening 36 to be attached to the pressurized source of a sprayable foam material 12. Generally, the attachment means will constitute screw threads (not shown). Typically, the pressurized source of a sprayable foam material 12 will have an externally threaded outlet (not shown) to which the outlet opening 36 of the handle portion 28 of the adapter-handle 14 is attachable via an internal thread formed in the outlet opening 36.

The adapter-handle 14 also includes the coupler portion 38. The coupler portion 38 includes a forward end 40 and an aft end 42, with a generally circular bore 44 therebetween. The generally circular bore 44 of the coupler portion 38 and the generally circular bore 34 of the handle portion 28 are in fluid communication with each other. The coupler portion 38 also includes an outlet opening or orifice 46 and also includes one or more grooves 48, which may be spiral grooves, about an exterior surface 50 of the coupler portion 38. The grooves 48 function to assist in securing a proximate end 52 of the flexible coupler 16 to the exterior surface 50 of the coupler portion 28.

Generally, the proximate end 52 of the flexible coupler 16 will be a friction fit with the exterior surface 50 of the coupler portion 28. The one or more grooves 48 formed on the exterior surface 50 of the coupler portion 28 assist an operator in sliding the proximate end 52 of the flexible coupler 16 onto the coupler portion 28 of the adapter-handle 14. Optionally, the proximate end 52 of the flexible coupler 16 may be secured to the exterior surface 50 of the coupler portion 28 by means of hose clamps (not shown). Many types of hose clamps are suitable and known in the art.

The adapter-handle 14 of the present invention also includes a finger grip portion 54 which includes a lower finger grip 56 and an upper finger grip 58. An underside of the finger grip 56 has a curved portion 62 and an underside of the upper finger grip 54 has two curved portions 60 and 64. The curved design of the lower and upper grip portions provides for an ergonomic grip that allows a user to readily grasp and use the adapter-handle 14, including in cold weather climates where the use of gloves may be required.

With continued reference to FIGS. 2-3, the flexible coupler 16 is a flexible tube having a distal end 68 and a proximate end 52 with a bore 70 therebetween. The proximate end 52 of the flexible coupler slides over the exterior surface 50 of the coupler portion 38 of the adapter-handle 14 in a friction fit relationship. The distal end 68 of the flexible coupler 16 likewise slide overs a rear exterior surface 70 of the nozzle 18 in a friction fit relationship. The rear exterior surface 70 of the nozzle 18 may be optionally be equipped with one or more grooves 72, which may be spiral grooves, to assist in sliding the distal end 68 of the flexible coupler 16 over the rear exterior surface 70 of the nozzle 18. Optionally, hose clamps (not shown) may be used at either or both of the proximate or the distal end connections. The nozzle 18 may also be equipped with a one or more ribs 74 formed on the nozzle. The one or more ribs 74 function as finger grips which allow a user to push exterior surface 70 of the nozzle 18 into the distal end 68 of the flexible coupler 16.

The flexible coupler 16 may be made from any number of materials including rubber, woven cloth and plastic materials. However, clear, semi-ridged or flexible plastic materials such as polypropylene or polyethylene are preferred because a user may monitor the flow of pressurized chemicals through the tube if the tube is constructed of a clear material.

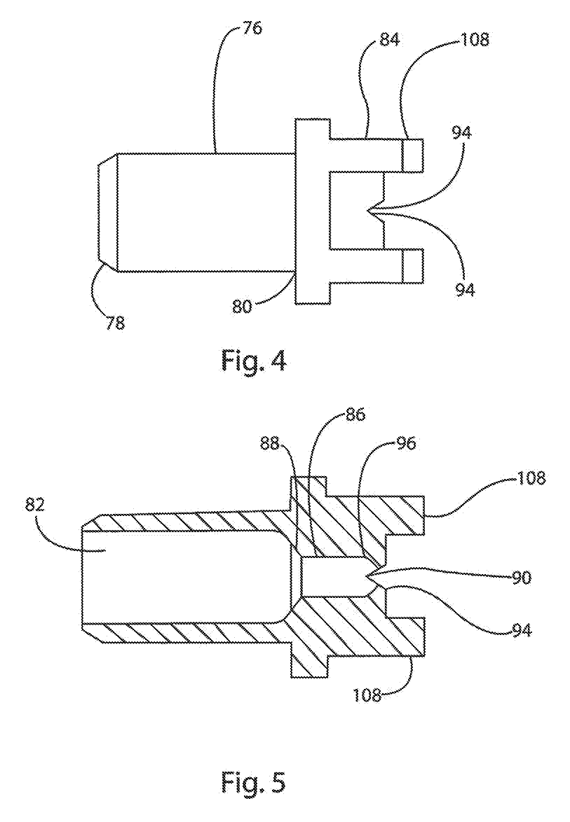

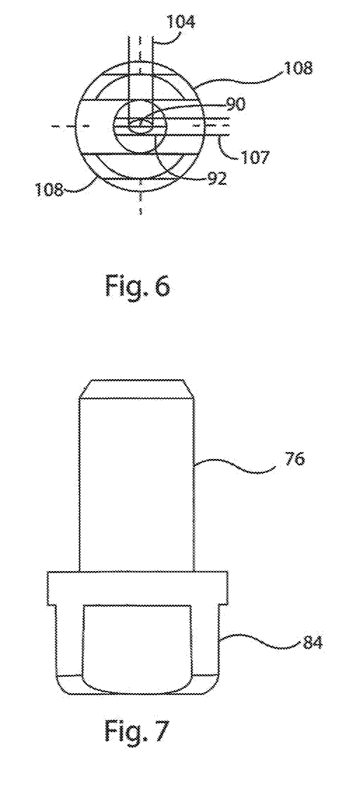

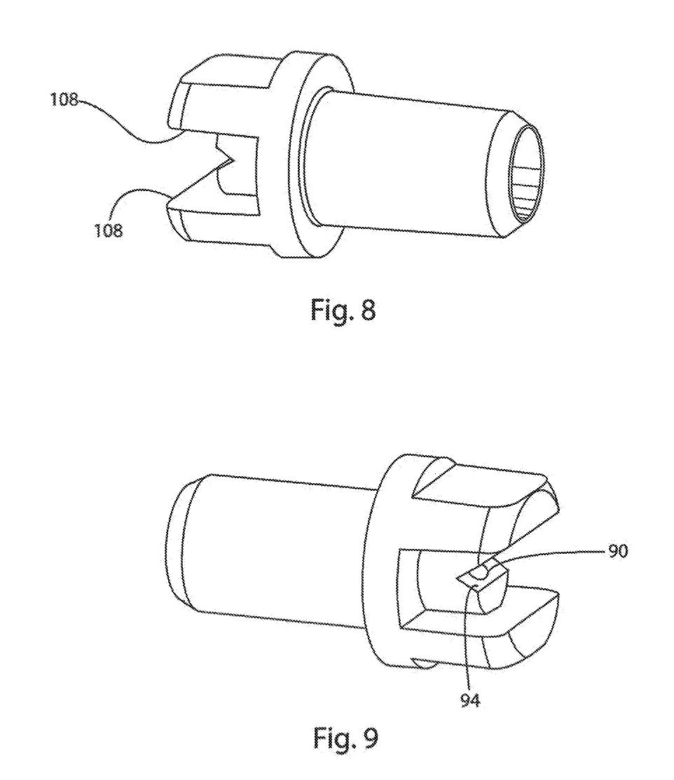

With reference to FIGS. 4-9, the nozzle 18 of the foam dispensing system of the present invention 10 includes a pressure chamber 76 having a proximate end 78 and distal end 80 with a generally circular bore 82 therebetween. Immediately adjacent, the pressure chamber 76 is a nozzle head 84. In fluid communication with the distal end 80 of the generally circular bore 82 of the pressure chamber 76 is a discharge tube 86 which has a proximate end 88 which is exposed to the generally circular bore 82 of the pressure chamber 76. The discharge tube 86 terminates at a distal end 96 which terminates in a discharge orifice 90, (best shown in FIGS. 6 and 9).

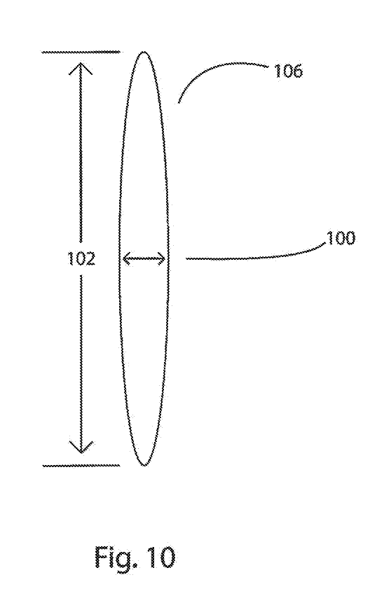

Formed into the nozzle head 84 are inwardly angled v-shaped walls 94 which form a slot 92 (see FIG. 6). The inwardly angled v-shaped walls 94 of slot 92 which intersects with and cuts through a portion of the discharge orifice 90 such that the discharge orifice 90 has an opening in the form of an elongated oval shape 98. (See FIG. 6.) The elongated oval shape 98 of the discharge port 90 causes foamable product to be dispensed from the pressurized source of sprayable foam material in a fan shaped pattern 106 (see FIG. 10). The length 104 of the elongated oval shape 98 of the discharge orifice 90 tends to control the effective length 102 of the spray pattern 106. (See FIG. 10.) The width 107 of the elongated oval shape 98 of the discharge port tends to control the width of the spray pattern 106. In the exemplary embodiment, the inwardly angled v-shaped walls 94 are about 60 degrees apart and experimentation has shown this degree of angular separation between the v-shaped walls to produce a discharge orifice 90 with an elongated oval shape 98 which produces an effective fan shaped pattern.

The nozzle head 84 of the nozzle 18 also includes spray limiting walls 108 which are disposed spaced apart from and parallel to the slot 92 of the nozzle head 84. The separation of the spray limiting walls 108 from the slot 92 aids in controlling the effective width 100 of the fan shaped spray pattern 106. The length 102 and width 100 and other shape characteristics of the spray pattern 106 are essentially controlled by the length 104 and width 107 of the elongated oval shape 98 of the discharge orifice 90 and to a lesser degree by the spray limiting walls 108 of the nozzle head 84.

In operation, the adapter-handle 14 is connected to the flexible coupler 16 which in is connected to the nozzle 18. For exemplary purposes only, FIG. 1 depicts the foam dispensing system of the present invention spraying foam material 20 against a surface, such as a wall 22. The adapter-handle 14, flexible coupler 16 and nozzle 18 forms an assembly whereby the adapter-handle 14 is attached (typically by threading) to the source of pressurized sprayable foam material 12. The source of pressurized sprayable foam material 12 has the ability to start and stop the flow of pressurized sprayable foam material. Once the flow of material is started foamable material flows through the adapter-handle 14, through the flexible coupler 16 and is dispensed in an atomized/droplet form by the nozzle 18. By means of the flexible coupler 16, foam may be sprayed in hard to reach places such as under surfaces, behind objects and the like. Another advantage of the foam dispensing system of the present invention is that the flexible coupler 16 and nozzle 18 do not need to be rinsed between uses where are significant advantages over prior systems which utilize spray guns which must be cleaned between uses.

The foregoing detailed description and appended drawings are intended as a description of the presently preferred embodiment of the invention and are not intended to represent the only forms in which the present invention may be constructed and/or utilized. Those skilled in the art will understand that modifications and alternative embodiments of the present invention which do not

1. A dispensing system for spraying pressurized foamable material, comprising:
a pressurized source of sprayable foamable material;
an adapter-handle, wherein the adapter-handle includes an upper finger grip and a lower finger grip, the upper finger grip and the lower fine grip being disposed in a mutually opposed relationship, an underside of the upper finger grip having at least one curved finger grasp portion and an underside of the lower finger grip having at least one curved finger grasp portion;
a nozzle;
wherein the nozzle includes a pressure chamber in fluid communication with a discharge tube, the discharge tube having a discharge orifice;
wherein the discharge orifice is in the shape of an elongated oval having a predetermined width and a predetermined length;
wherein a slot having v-shaped walls intersects the discharge orifice and forms the elongated oval shape of the orifice;
wherein the nozzle includes a spray limiting wall disposed on each side of and parallel to the slot having v-shaped walls;
a flexible tubular coupler interconnecting the nozzle and the adapter-handle;
wherein the pressurized source of sprayable foamable material, adapter-handle, tubular coupler and the nozzle are in fluid communication; and
wherein when sprayable foamable material is released from the pressurized source of sprayable foamable material, the sprayable foamable material exits the nozzle in a fan shaped spray pattern.

2. The dispensing system for spraying pressurized foamable material of claim 1, wherein the angle between the v-shaped walls of the slot is about 60 degrees.

3. The dispensing system for spraying pressurized foamable material of claim 1, wherein the the at least one curved finger grasp portion of the upper finger grip comprises two curved finger grasp portions and the at least one curved finger grasp portion of the lower finger grip comprises one finger grasp portion.

4. The dispensing system for spraying pressurized foamable material of claim 1, wherein the nozzle has a circular exterior surface including at least one groove wherein the circular exterior surface of the nozzle is insertable into an end of the tubular coupler.

5. The dispensing system for spraying pressurized foamable material of claim 1, wherein the adapter-handle includes a handle portion and a coupler portion wherein the handle portion includes means to attach to the source of pressurized sprayable foamable material and is in fluid communication with the coupler portion.

6. The dispensing system for spraying pressurized foamable material of claim 5, wherein the coupler portion of the adapter-handle includes a circular exterior surface having at least one groove insertable into an end of the tubular coupler.

7. A dispensing system for pressurized foamable material, comprising:
a pressurized source of sprayable foamable material;
an adapter-handle, wherein the adapter-handle includes an upper finger grip and a lower finger grip, the upper finger grip and the lower finger grip being disposed in a mutually opposed relationship, an underside of the upper finger grip having at least one curved finger grasp portion and an underside of the lower finger grip having at least one curved finger grasp portion;
a nozzle;
a flexible tubular coupler interconnecting the nozzle and the adapter-handle; and
wherein the pressurized source of sprayable foamable material, adapter-handle, tubular coupler and the nozzle are in fluid communication;
wherein when sprayable foamable material is released from the pressurized source of sprayable foamable material, the material exits the nozzle.

8. The system for dispensing pressurized foamable material of claim 7, wherein the nozzle includes a pressure chamber in fluid communication with a discharge tube, the discharge tube having a discharge orifice.

9. The system for dispensing pressurized foamable material of claim 8, wherein the discharge orifice is in the shape of an elongated oval having a predetermined width and a predetermined length.

10. The system for dispensing pressurized foamable material of claim 9, wherein a slot having v-shaped walls intersects the discharge orifice and forms the elongated oval shape of the orifice.

11. The system for dispensing pressurized foamable material of claim 10, wherein the angle between the v-shaped walls of the slot is about 60 degrees.

12. The system for dispensing pressurized foamable material of claim 11, wherein the nozzle includes a spray limiting wall disposed on each side of and parallel to the slot having v-shaped walls.

13. The system for dispensing pressurized foamable material of claim 7, wherein the sprayable foamable material exits the nozzle in a fan shaped spray pattern.

14. The system for dispensing pressurized foamable material of claim 7, wherein the nozzle has a circular exterior surface including at least one groove wherein the circular exterior surface of the nozzle is insertable into an end of the tubular coupler.

15. The system for dispensing pressurized foamable material of claim 7 wherein the at least one curved finger grasp portion of the upper finger grip comprises two curved finger grasp portions and the at least one curved finger grasp portion of the lower finger grip comprises one finger grasp portion.

16. The system for dispensing pressurized foamable material of claim 7, wherein the adapter-handle includes a handle portion and a coupler portion wherein the handle portion includes means to attach to the source of pressurized sprayable foam material and is in fluid communication with the coupler portion.

17. The system for dispensing pressurized foamable material of claim 16, wherein the coupler portion of the adapter-handle includes a circular exterior surface having at least one groove insertable into an end of the tubular coupler.

18. A dispensing system for pressurized foamable material, comprising:
a pressurized source of sprayable foamable material;
an adapter-handle;
wherein the adapter-handle includes a handle portion and a coupler portion wherein the handle portion includes means to attach to the source of pressurized sprayable foamable material and is in fluid communication with the coupler portion;
wherein coupler portion of the adapter-handle includes a circular exterior surface having at least one groove and is insertable into an end of the tubular coupler;
wherein the adapter-handle includes an upper finger grip and a lower finger grip, the upper finger grip and the lower finger grip being disposed in a mutually opposed relationship, an underside of the upper finger grip having two curved finger grasp portions and an underside of the lower finger grip having one curved finger grasp portion;
a nozzle;
wherein the nozzle includes a pressure chamber in fluid communication with a discharge tube, the discharge tube having a discharge orifice;
wherein the discharge orifice is in the shape of an elongated oval having a predetermined width and a predetermined length;
wherein a slot having v-shaped walls intersects the discharge orifice and forms the elongated oval shape of the orifice;
wherein the nozzle includes a spray limiting wall disposed on each side of and parallel to the slot having v-shaped walls;
a coupler interconnecting the nozzle and the adapter handle; and
wherein when sprayable foamable material is released from the pressurized source for sprayable foamable material, the sprayable foamable material exits the nozzle.

19. The system for dispensing pressurized foamable material of claim 18 wherein the angle between the v-shaped walls of the slot is about 60 degrees.

20. The system for dispensing pressurized foamable material of claim 18, wherein an exterior surface of the nozzle includes at least one finger grip rib.
